(19) United States
(12) Patent Application Publication
(10) Pub. No.: US 2011/0205313 A1
(43) Pub. Date: Aug. 25, 2011

(54) Inkjet print head and method of manufacturing the same

(75) Inventors: Jae Hun Kim, Seoul (KR); Yun Sung Kang, Suwon (KR); Jae Woo Joung, Suwon (KR); Ju Hwan Yang, Suwon (KR)

(73) Assignee: SAMSUNG ELECTRO-MECHANICS CO., LTD., Suwon (KR)

(21) Appl. No.: 12/923,830

(22) Filed: Oct. 8, 2010

(30) Foreign Application Priority Data
Feb. 23, 2010 (KR) 10-2010-0016253

(51) Int. Cl. B41J 2/045

(52) U.S. Cl. 347/71

(57) ABSTRACT

There is provided an inkjet print head including: a pressure chamber storing ink in order to eject the ink to a nozzle; a piezoelectric actuator receiving part being recessed in order to correspond to the pressure chamber in a direction of the pressure chamber; and a piezoelectric actuator received in the piezoelectric actuator receiving part, in which viscous liquid having piezoelectric properties is filled and hardened, and supplying the pressure chamber with a driving force for ejection of the ink.

### CROSS-REFERENCE TO RELATED APPLICATIONS

This application claims the priority of Korean Patent Application No. 10-2010-0016253 filed on Feb. 23, 2010, in the Korean Intellectual Property Office, the disclosure of which is incorporated herein by reference.

### BACKGROUND OF THE INVENTION

1. Field of the Invention

The present invention relates to an inkjet print head and a method of manufacturing the same, and more particularly, to an inkjet print head allowing for the realization of low-voltage driving and the enhancement of driving efficiency and a method of manufacturing the same.

2. Description of the Related Art

In general, an inkjet print head converts electrical signals into physical impulses so that ink droplets are ejected through a small nozzle.

In recent years, a piezoelectric inkjet print head has been used in industrial inkjet printers. For example, it is used to directly form a circuit pattern by spraying ink prepared by melting a metal such as gold or silver onto a flexible printed circuit board (PCB). It is also used for creating industrial graphics, or for the manufacturing of a liquid crystal display (LCD), an organic light emitting diode (OLED) and a solar cell.

In general, an inkjet print head includes an inlet and an outlet through which ink in a cartridge is drawn and ejected, respectively, a manifold storing the ink being indrawn, and a chamber transferring the driving force of an actuator so as to move the ink stored in the manifold toward a nozzle. In order to eject the ink in the chamber to the outside, a piezoelectric actuator formed of a piezoelectric material is mounted on a surface of the inkjet print head.

According to the related art, the mounting of a piezoelectric actuator on an inkjet print head has been performed by a screen-printing method or an epoxy bonding method for bulk ceramics.

However, the piezoelectric actuator mounted by the above-described methods is thick, so it requires high voltage in order to be driven.

Accordingly, low-voltage driving is impossible, and driving efficiency versus driving voltage is reduced.

In addition, the screen-printing method and the epoxy bonding method for bulk ceramics according to the related art increase manufacturing costs. Furthermore, since they have difficulty in controlling the width and height of a piezoelectric material uniformly, this causes a problem in the forming of a piezoelectric actuator having a uniform shape.

### SUMMARY OF THE INVENTION

An aspect of the present invention provides an inkjet print head and a manufacturing method thereof allowing for the forming of a piezoelectric actuator having a uniform shape and the enhancement of driving efficiency versus driving voltage.

According to an aspect of the present invention, there is provided an inkjet print head including: a pressure chamber storing ink in order to eject the ink to a nozzle; a piezoelectric actuator receiving part being recessed in order to correspond to the pressure chamber in a direction of the pressure chamber; and a piezoelectric actuator received in the piezoelectric actuator receiving part, in which viscous liquid having piezoelectric properties is filled and hardened, and supplying the pressure chamber with a driving force for ejection of the ink.

The piezoelectric actuator receiving part may have at least one inclined surface.

The piezoelectric actuator may include a piezoelectric layer formed by inkjet printing of the viscous liquid having piezoelectric properties.

The piezoelectric actuator may include upper and lower electrodes supplying a driving voltage, at least one of which is formed by inkjet printing of an electrode material.

The lower electrode may include a wire for a connection with a flexible printed circuit board supplying a power source.

The wire may be formed by inkjet printing of an electrode material.

The piezoelectric actuator may include a diffusion barrier film in order to prevent a reaction between the viscous liquid having piezoelectric properties and an outer surface of the pressure chamber.

The diffusion barrier film may be deposited by any one of E-beam evaporation, chemical vapor deposition, physical vapor deposition, plating and screen-printing.

According to another aspect of the present invention, there is provided an inkjet print head including: an upper substrate having a pressure chamber storing ink in order to eject the ink to a nozzle; a piezoelectric actuator receiving part being recessed in the upper substrate corresponding to the pressure chamber in a direction of the pressure chamber; a piezoelectric actuator received in the piezoelectric actuator receiving part, in which viscous liquid having piezoelectric properties is filled and hardened, and supplying the pressure chamber with a driving force for ejection of the ink; and a lower substrate having the nozzle being in communication with the pressure chamber and ejecting the ink.

The piezoelectric actuator receiving part may have at least one inclined surface.

The piezoelectric actuator may include a piezoelectric layer formed by inkjet printing of the viscous liquid having piezoelectric properties.

The piezoelectric actuator may be formed in the same plane as the upper substrate.

The piezoelectric actuator may include upper and lower electrodes supplying a driving voltage, at least one of which is formed by inkjet printing of an electrode material.

The lower electrode may include a wire for a connection with a flexible printed circuit board supplying a power source.

The wire may be formed by inkjet printing of an electrode material.

The piezoelectric actuator may include a diffusion barrier film in order to prevent a reaction between the viscous liquid having piezoelectric properties and an outer surface of the pressure chamber.

The diffusion barrier film may be deposited by any one of E-beam evaporation, chemical vapor deposition, physical vapor deposition, plating and screen-printing.

According to another aspect of the present invention, there is provided a method of manufacturing an inkjet print head, the method including: forming a pressure chamber in a substrate in order to eject ink to a nozzle, the pressure chamber storing the ink; forming a piezoelectric actuator receiving part to be recessed in the substrate corresponding to the pressure chamber in a direction of the pressure chamber; and providing a piezoelectric actuator received in the piezoelectric actuator receiving part, in which viscous liquid having piezoelectric properties is filled and hardened, the piezoelectric actuator supplying the pressure chamber with a driving force for ejection of the ink.

The piezoelectric actuator receiving part may have at least one inclined surface.

The piezoelectric actuator may include upper and lower electrodes supplying a driving voltage and a piezoelectric layer disposed between the upper electrode and the lower electrode and supplying the driving force.

The method may further include forming a diffusion barrier film at a bottom of the piezoelectric actuator in order to prevent a reaction between the viscous liquid having piezoelectric properties and an outer surface of the pressure chamber.

The diffusion barrier film may be deposited by any one of E-beam evaporation, chemical vapor deposition, physical vapor deposition, plating and screen-printing.

At least one of the upper and lower electrodes may be formed by inkjet printing of an electrode material.

The piezoelectric layer may be formed by inkjet printing of the viscous liquid having piezoelectric properties and hardening thereof.

The piezoelectric layer may be formed such that the viscous liquid having piezoelectric properties is fully filled in the piezoelectric actuator receiving part and subsequently sintered, or the viscous liquid having piezoelectric properties is filled in part of the piezoelectric actuator receiving part and subsequently sintered in a repeated manner until being fully filled.

The lower electrode may include a wire for a connection with a flexible printed circuit board supplying a power source.

The wire may be formed by inkjet printing of an electrode material.

The method may further include performing a poling process in order to make a direction of dipoles of the piezoelectric actuator consistent.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cut-away perspective view illustrating an inkjet print head according to an exemplary embodiment of the present invention;

FIG. 2 is a schematic cross-sectional view illustrating an inkjet print head according to an exemplary embodiment of the present invention;

FIG. 3 is a schematic plan view illustrating an inkjet print head according to an exemplary embodiment of the present invention;

FIG. 4 is a schematic cross-sectional view illustrating an inkjet print head according to another exemplary embodiment of the present invention;

FIGS. 5 through 9 are schematic cross-sectional views illustrating a method of manufacturing an inkjet print head according to another exemplary embodiment of the present invention; and

FIG. 10 is a schematic cross-sectional view illustrating a poling process of an inkjet print head according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like elements.

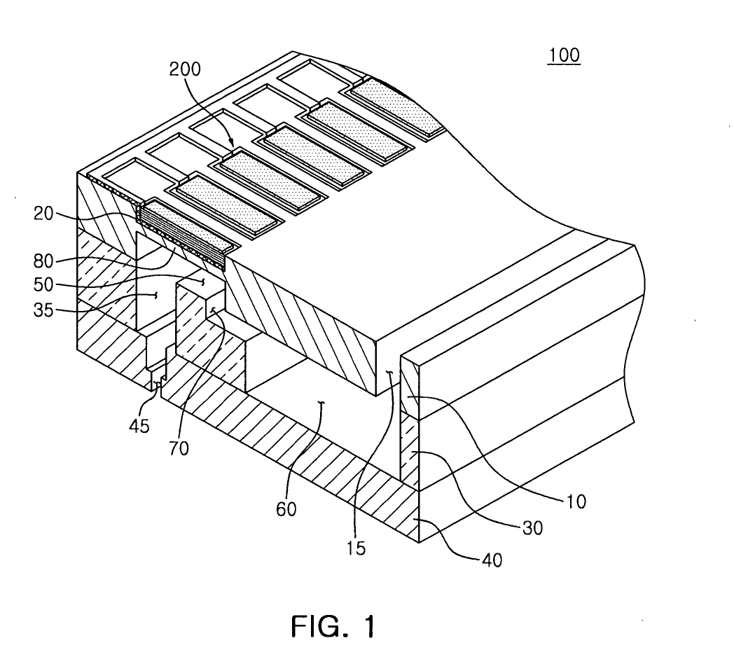

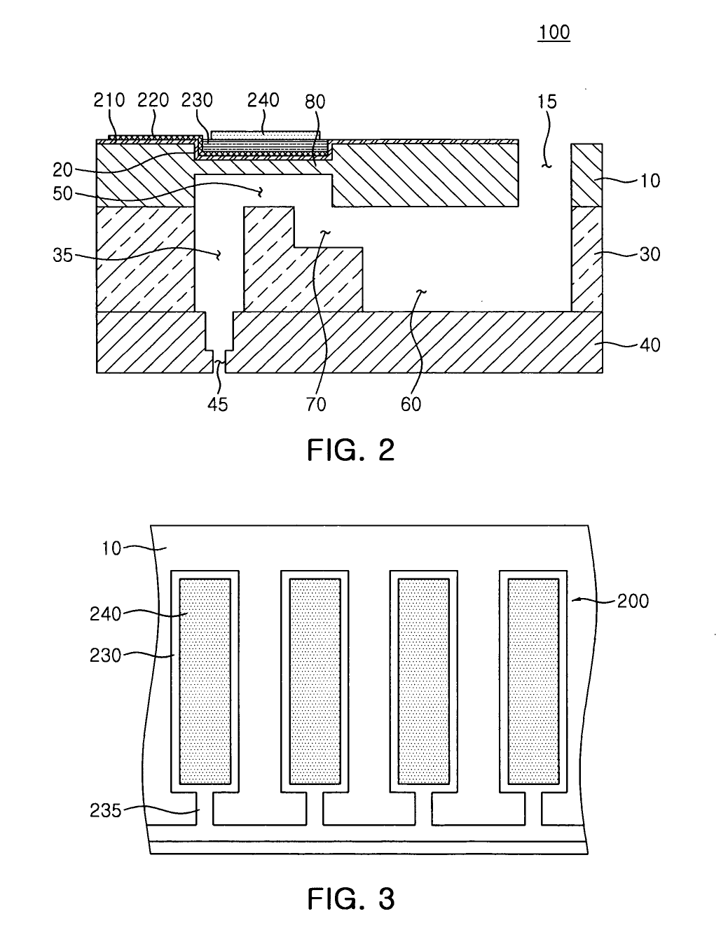

FIG. 1 is a schematic cut-away perspective view illustrating an inkjet print head according to an exemplary embodiment of the present invention. FIG. 2 is a schematic cross-sectional view illustrating an inkjet print head according to an exemplary embodiment of the present invention. FIG. 3 is a schematic plan view illustrating an inkjet print head according to an exemplary embodiment of the present invention.

With reference to FIGS. 1 through 3, an inkjet print head 100 according to an exemplary embodiment of the invention may include an upper substrate 10, a piezoelectric actuator receiving part 20, an intermediate substrate 30, a lower substrate 40, and a piezoelectric actuator 200.

The upper substrate 10 has a plurality of pressure chambers 50 regularly formed therein and an ink inlet 15 through which ink is drawn in. Here, the ink inlet 15 is directly connected to a manifold 60, and the manifold 60 supplies ink to the pressure chambers 50 through a restrictor 70.

Here, the manifold 60 may be a single large space to which the plurality of pressure chambers 50 are connected. However, the invention is not limited thereto. A plurality of manifolds 60 may be formed to correspond to the individual pressure chambers 50.

Also, the manifold 60 may be prepared by forming a recess having an inner space in the intermediate substrate 30 and the lower substrate 40.

Similarly, only one ink inlet 15 may be formed to correspond to one manifold 60. However, when the plurality of manifolds 60 are formed, a plurality of ink inlets may be formed to correspond to the individual manifolds 60.

The pressure chambers 50 are provided at positions located under the piezoelectric actuator 200 to be described below. That is, the pressure chambers 50 are formed inside the upper substrate 10 and store ink so as to eject the ink to nozzles 45.

Here, a portion of the upper substrate 10 that forms the ceiling of the pressure chambers 50 serves as a membrane 80.

The piezoelectric actuator receiving part 20 may be provided on the outer surface of the upper substrate 10 corresponding to the pressure chambers 50, particularly, to be recessed in the membrane 80 in the direction of the pressure chambers 50. The piezoelectric actuator receiving part 20 may receive the piezoelectric actuator 200.

The depth of the piezoelectric actuator receiving part 20 may be almost the same as the height of the piezoelectric actuator 200 so that the overall volume of the inkjet print head 100 may be reduced.

Therefore, when a driving signal is applied to the piezoelectric actuator 200 in order to eject ink, the piezoelectric actuator 200 received in the piezoelectric actuator receiving part 20 and the membrane 80 thereunder are deformed to thereby reduce the volumes of the pressure chambers 50.

Here, the reduction in the volumes of the pressure chambers 50 increases the pressure inside the pressure chambers 50, so that the ink inside the pressure chambers 50 is ejected to the outside through dampers 35 and the nozzles 45.

The upper substrate 10 may be a silicon-on-insulator (SOI) substrate having an intermediate oxide film serving as an etch-stop layer in order to exactly set the heights of the pressure chambers 50.

The intermediate substrate 30 may include the manifold 60 having a large length extending in a longitudinal direction and the dampers 35 connecting the nozzles 45 and the pressure chambers 50.

The manifold 60 is supplied with ink through the ink inlet 15 and supplies the ink to the pressure chambers 50. The manifold 60 and the pressure chambers 50 are connected with each other through the restrictor 70.

The dampers 35 receive the ink ejected from the pressure chambers 50 through the piezoelectric actuator 200 and eject the received ink to the outside through the nozzles 45.

The dampers 35 may have a multi-stage configuration by which the amount of ink received from the pressure chambers 50 and the amount of ink ejected through the nozzles 45 may be controlled.

Here, the dampers 35 are optional. When the dampers 35 are removed, the inkjet print head 100 only includes the upper substrate 10 and the lower substrate 40 to be described below.

The lower substrate 40 corresponds to the pressure chambers 50 and includes the nozzles 45 through which the ink passing through the dampers 35 is ejected to the outside. The lower substrate 40 is bonded to the bottom of the intermediate substrate 30.

The nozzles 45 eject droplets of the ink moving through a flow path formed inside the inkjet print head 100.

Here, silicon substrates being widely used for semiconductor integrated circuits may be used as the upper substrate 10, the intermediate substrate 30, and the lower substrate 40. However, the upper substrate 10, the intermediate substrate 30, and the lower substrate 40 are not limited to silicon substrates, and may be formed of various materials.

The piezoelectric actuator 200 is received in the piezoelectric actuator receiving part 20, in which viscous liquid having piezoelectric properties may be filled and be subsequently hardened. The piezoelectric actuator 200 may supply a driving force for ink ejection to the pressure chambers 50.

Here, the piezoelectric actuator 200 is received in the piezoelectric actuator receiving part 20 such that it may be formed in the same plane as the upper substrate 10. This reduces the thickness of the membrane 80, and thus driving efficiency may be increased.

Also, the width and height of the piezoelectric actuator 200 may be uniformly maintained due to the piezoelectric actuator receiving part 20 so that the piezoelectric actuator 200 may be formed to have a uniform shape. This causes an increase in nozzle density of the inkjet print head 100.

The piezoelectric actuator 200 includes a lower electrode 220, a piezoelectric layer 230, and an upper electrode 240.

The lower electrode 220 supplies a driving voltage in order to supply a driving force to the pressure chambers 50. The lower electrode 220 may be formed by the inkjet printing of an electrode material on the upper substrate 10.

The lower electrode 220 may be formed of any one of materials such as Pt, Au, Ag, Ni, Ti and Cu.

The lower electrode 220 may include a wire 235 for a connection with a flexible printed circuit board (not shown) supplying a power source. The wire 235 may be formed by the inkjet printing of an electrode material.

The piezoelectric layer 230 may be formed by hardening viscous liquid having piezoelectric properties between the lower electrode 220 and the upper electrode 240 using an inkjet printing method.

The piezoelectric layer 230 is capable of converting electrical energy into mechanical energy or vice versa. The piezoelectric layer 230 may be formed of Plumbum Zirconate Titanate (PZT: Pb (Zr, Ti) O₃) ceramics.

When voltage is applied to the piezoelectric layer 230, the membrane 80 is deformed upwardly and downwardly so that a driving force is transferred in a vertical direction. Due to the driving force, the ink inside the pressure chambers 50 may be ejected to the outside through the nozzles 45.

The nozzles 45 are formed toward the side surface of the lower substrate 40 in a width direction thereof. Accordingly, the ink may be ejected in a vertical direction with respect to the direction of transferred driving force inside the pressure chambers 50.

Like the lower electrode 220, the upper electrode 240 supplies a driving voltage in order to supply a driving force to the pressure chambers 50. The upper electrode 240 may be formed of any one of materials such as Pt, Au, Ag, Ni, Ti and Cu.

Also, the upper electrode 240 may be formed by inkjet printing, E-beam evaporation, chemical vapor deposition (CVD), sputtering, screen-printing, plating, and the like, of an electrode material on the upper surface of the piezoelectric layer 230.

A diffusion barrier film 210 may be provided between the piezoelectric actuator 200 and the membrane 80 in order to prevent a reaction between the viscous liquid having piezoelectric properties and the outer surface of the pressure chambers 50.

Here, the diffusion barrier film 210 may be deposited by any one of E-beam evaporation, CVD, physical vapor deposition (PVD), plating and screen-printing.

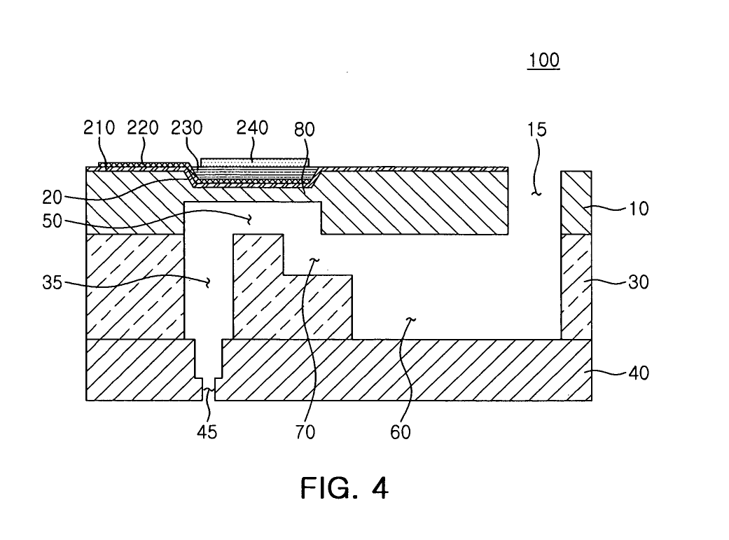

FIG. 4 is a schematic cross-sectional view illustrating an inkjet print head according to another exemplary embodiment of the present invention.

With reference to FIG. 4, the inkjet print head 100 according to this embodiment may include the piezoelectric actuator receiving part 20 having at least one inclined surface. The other elements of this embodiment are the same as those of the aforementioned embodiment, so a detailed description thereof will be omitted.

According to this embodiment, at least one surface of the piezoelectric actuator receiving part 20 is inclined so that porosity may be reduced during the process of constructing the piezoelectric actuator 200 by inkjet printing.

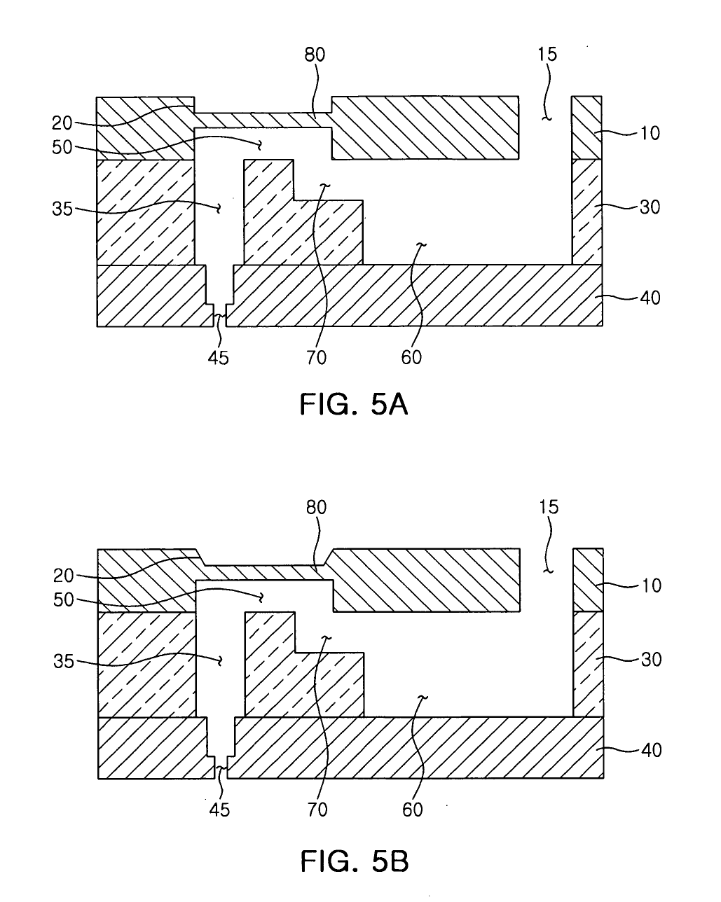

FIGS. 5 through 9 are schematic cross-sectional views illustrating a method of manufacturing an inkjet print head according to another exemplary embodiment of the present invention.

With reference to FIG. 5, the pressure chamber 50 is provided for storing ink to be ejected through the nozzle 45. A recess may be formed in the outer surface of the upper substrate 10 corresponding to the pressure chamber 50 in the direction of the pressure chamber 50.

In other words, the recess may be formed in the membrane 80 of the upper substrate 10 corresponding to the pressure chamber 50 in the direction of the pressure chamber 50.

The recess may be the piezoelectric actuator receiving part 20 in which the piezoelectric actuator 200 is received. As shown in FIG. 5B, at least one surface of the piezoelectric actuator receiving part 20 may be inclined.

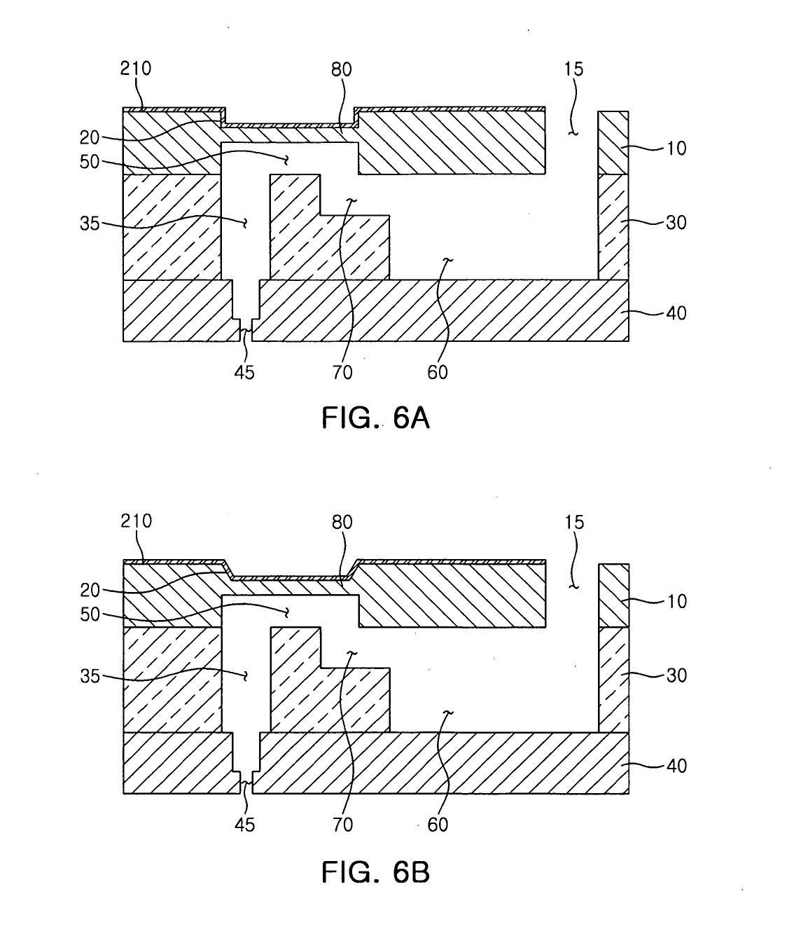

With reference to FIG. 6, the diffusion barrier film 210 may be formed on the upper surface of the piezoelectric actuator receiving part 20 in order to prevent a reaction with the upper substrate 10 during the sintering of the piezoelectric layer 230.

The diffusion barrier film 210 may be deposited by any one of E-beam evaporation, CVD, PVD, plating and screen-printing.

Since the diffusion barrier film 210 is formed for preventing the reaction with the upper substrate 10, the forming of the diffusion barrier film 210 is not necessarily essential, but it may be preferably performed.

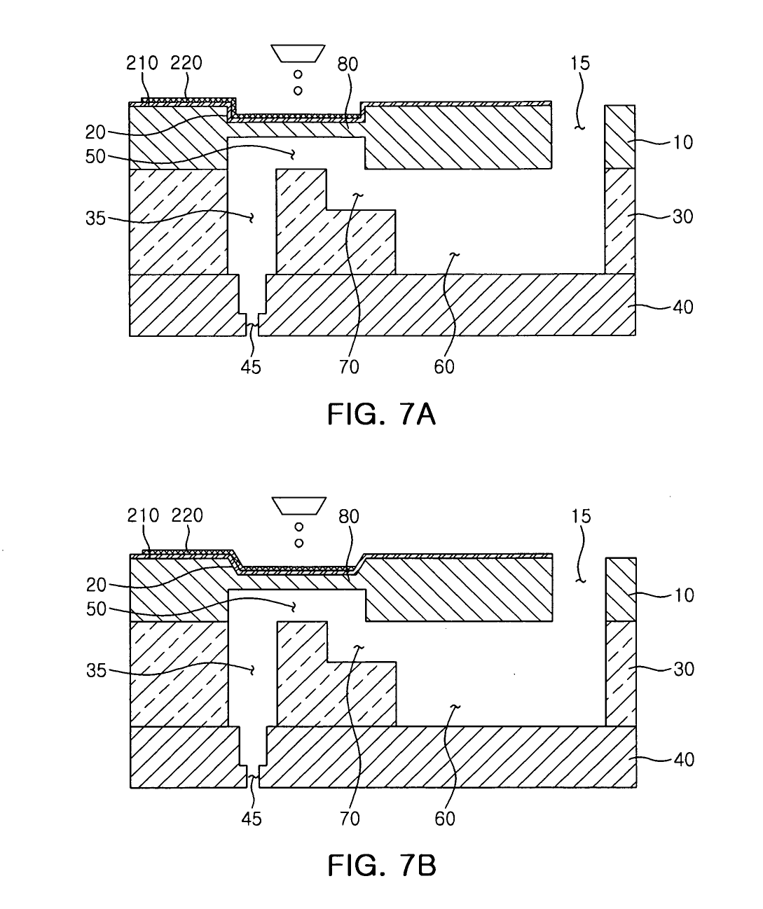

With reference to FIGS. 7 through 9, the piezoelectric actuator 200 may be disposed on the upper surface of the diffusion barrier film 210 or the upper surface of the membrane 80 of the upper substrate 10.

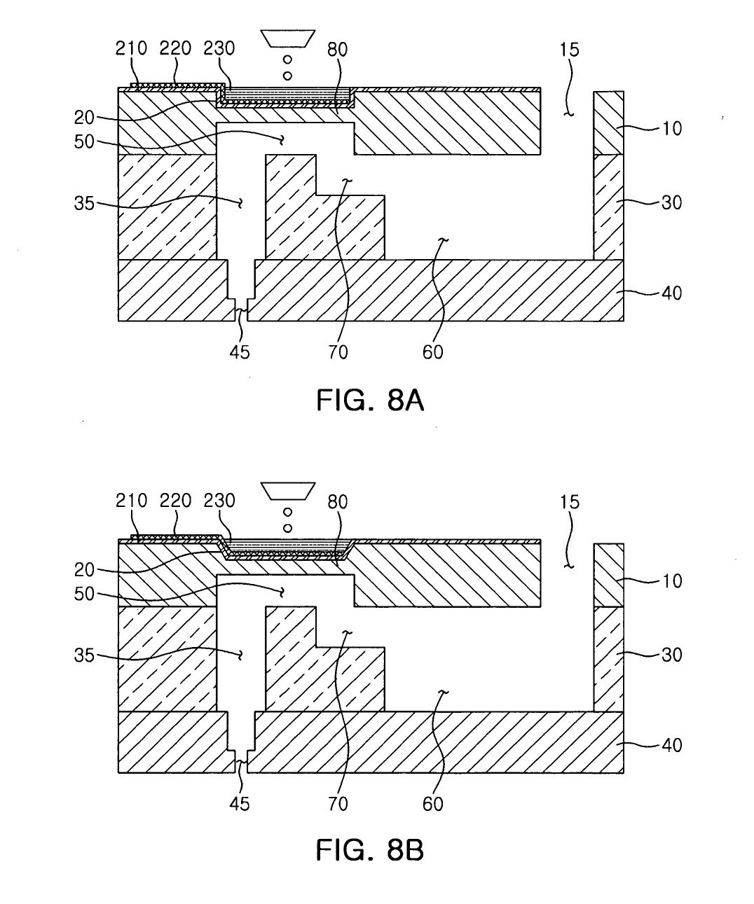

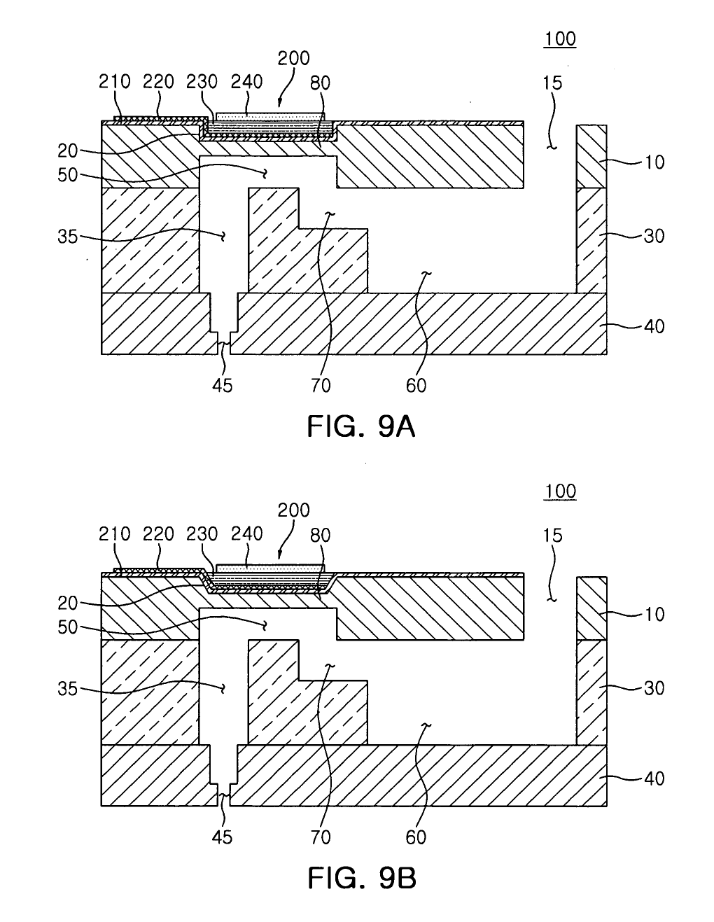

The piezoelectric actuator 200 may be formed in such a manner that the lower electrode 220 is disposed as shown in FIG. 7 and the piezoelectric layer 230 is fixed as shown in FIG. 8, and then the upper electrode 240 is provided on the upper surface of the piezoelectric layer 230 as shown in FIG. 9.

The lower electrode 220 may be formed by the inkjet printing of an electrical material. The lower electrode 220 may include the wire 235 for a connection with a flexible printed circuit board (not shown) supplying a power source. The wire 235 may be formed by the inkjet printing of an electrode material.

The piezoelectric layer 230 may be formed by the inkjet printing of viscous liquid having piezoelectric properties and the hardening thereof. The viscous liquid having piezoelectric properties may be fully filled in the piezoelectric actuator receiving part 20 and be subsequently sintered. Otherwise, the viscous liquid having piezoelectric properties may be filled in part of the piezoelectric actuator receiving part 20 and be subsequently sintered, and then the filling and sintering process may be repeated.

The repetition of the filling and sintering process may reduce porosity. Therefore, the latter process is preferable over the former.

The upper electrode 240 may be disposed on the upper surface of the piezoelectric layer 230. The upper electrode 240 may be formed by inkjet printing, E-beam evaporation, CVD, sputtering, screen-printing, plating and the like.

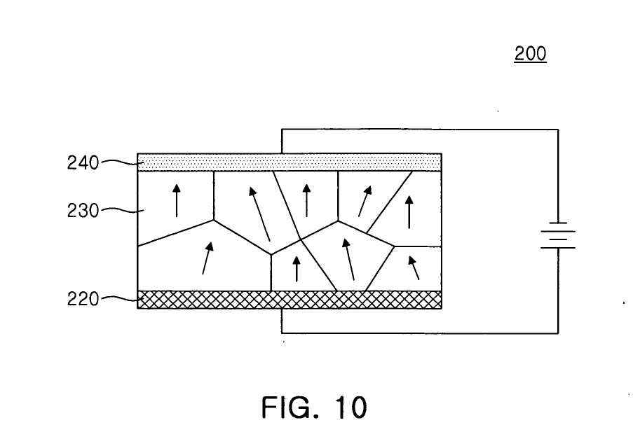

FIG. 10 is a schematic cross-sectional view illustrating a poling process of an inkjet print head according to another exemplary embodiment of the present invention.

With reference to FIG. 10, during a poling process in which voltage is applied to the upper electrode 240 and the lower electrode 220, the direction of dipoles of the piezoelectric actuator 200 may be consistent.

The poling process establishes an electric field by applying voltage to the upper electrode 240 and the lower electrode 220, and the direction of adjacent dipoles is gradually consistent due to the electric field. During the poling process, the piezoelectric layer 230 may be compact and have electrical characteristics.

Accordingly, the poling process may allow the piezoelectric layer 230 to function as the piezoelectric actuator 200.

According to the above-described exemplary embodiments, the thickness of the membrane 80 is reduced by the piezoelectric actuator receiving part 20 being recessed so that low-voltage driving may be realized and driving efficiency may be enhanced.

Also, the piezoelectric actuator receiving part 20 being recessed contributes to maintaining a uniform size and volume of the piezoelectric layer 230 so that the piezoelectric actuator 200 may have a uniform shape and the nozzle density of the inkjet print head 100 may be increased.

As set forth above, in an inkjet print head and a method of manufacturing the same according to exemplary embodiments of the invention, the forming of a piezoelectric actuator having a uniform shape is facilitated so that the realization of low-voltage driving, the enhancement of driving efficiency and the increase of nozzle density may be achieved.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet print head comprising:
a pressure chamber storing ink in order to eject the ink to a nozzle;
a piezoelectric actuator receiving part being recessed in order to correspond to the pressure chamber in a direction of the pressure chamber; and
a piezoelectric actuator received in the piezoelectric actuator receiving part, in which viscous liquid having piezoelectric properties is filled and hardened, and supplying the pressure chamber with a driving force for ejection of the ink.

2. The inkjet print head of claim 1, wherein the piezoelectric actuator receiving part has at least one inclined surface.

3. The inkjet print head of claim 1, wherein the piezoelectric actuator includes a piezoelectric layer formed by inkjet printing of the viscous liquid having piezoelectric properties.

4. The inkjet print head of claim 1, wherein the piezoelectric actuator includes upper and lower electrodes supplying a driving voltage, at least one of which is formed by inkjet printing of an electrode material.

5. The inkjet print head of claim 4, wherein the lower electrode includes a wire for a connection with a flexible printed circuit board supplying a power source.

6. The inkjet print head of claim 5, wherein the wire is formed by inkjet printing of an electrode material.

7. The inkjet print head of claim 1, wherein the piezoelectric actuator includes a diffusion barrier film in order to prevent a reaction between the viscous liquid having piezoelectric properties and an outer surface of the pressure chamber.

8. The inkjet print head of claim 7, wherein the diffusion barrier film is deposited by any one of E-beam evaporation, chemical vapor deposition, physical vapor deposition, plating and screen-printing.

9. An inkjet print head comprising:
an upper substrate having a pressure chamber storing ink in order to eject the ink to a nozzle;
a piezoelectric actuator receiving part being recessed in the upper substrate corresponding to the pressure chamber in a direction of the pressure chamber;
a piezoelectric actuator received in the piezoelectric actuator receiving part, in which viscous liquid having piezoelectric properties is filled and hardened, and supplying the pressure chamber with a driving force for ejection of the ink; and
a lower substrate having the nozzle being in communication with the pressure chamber and ejecting the ink.

10. The inkjet print head of claim 9, wherein the piezoelectric actuator receiving part has at least one inclined surface .

11. The inkjet print head of claim 9, wherein the piezoelectric actuator includes a piezoelectric layer formed by inkjet printing of the viscous liquid having piezoelectric properties.

12. The inkjet print head of claim 9, wherein the piezoelectric actuator is formed in the same plane as the upper substrate.

13. The inkjet print head of claim 9, wherein the piezoelectric actuator includes upper and lower electrodes supplying a driving voltage, at least one of which is formed by inkjet printing of an electrode material.

14. The inkjet print head of claim 13, wherein the lower electrode includes a wire for a connection with a flexible printed circuit board supplying a power source.

15. The inkjet print head of claim 14, wherein the wire is formed by inkjet printing of an electrode material.

16. The inkjet print head of claim 9, wherein the piezoelectric actuator includes a diffusion barrier film in order to prevent a reaction between the viscous liquid having piezoelectric properties and an outer surface of the pressure chamber.

17. The inkjet print head of claim 16, wherein the diffusion barrier film is deposited by any one of E-beam evaporation, chemical vapor deposition, physical vapor deposition, plating and screen-printing.

18. A method of manufacturing an inkjet print head, the method comprising:
forming a pressure chamber in a substrate in order to eject ink to a nozzle, the pressure chamber storing the ink;
forming a piezoelectric actuator receiving part to be recessed in the substrate corresponding to the pressure chamber in a direction of the pressure chamber; and
providing a piezoelectric actuator received in the piezoelectric actuator receiving part, in which viscous liquid having piezoelectric properties is filled and hardened, the piezoelectric actuator supplying the pressure chamber with a driving force for ejection of the ink.

19. The method of claim 18, wherein the piezoelectric actuator receiving part has at least one inclined surface.

20. The method of claim 18, wherein the piezoelectric actuator includes upper and lower electrodes supplying a driving voltage and a piezoelectric layer disposed between the upper electrode and the lower electrode and supplying the driving force.

21. The method of claim 18, further comprising forming a diffusion barrier film at a bottom of the piezoelectric actuator in order to prevent a reaction between the viscous liquid having piezoelectric properties and an outer surface of the pressure chamber.

22. The method of claim 21, wherein the diffusion barrier film is deposited by any one of E-beam evaporation, chemical vapor deposition, physical vapor deposition, plating and screen-printing.

23. The method of claim 20, wherein at least one of the upper and lower electrodes is formed by inkjet printing of an electrode material.

24. The method of claim 20, wherein the piezoelectric layer is formed by inkjet printing of the viscous liquid having piezoelectric properties and hardening thereof.

25. The method of claim 24, wherein the piezoelectric layer is formed such that the viscous liquid having piezoelectric properties is fully filled in the piezoelectric actuator receiving part and subsequently sintered, or the viscous liquid having piezoelectric properties is filled in part of the piezoelectric actuator receiving part and subsequently sintered in a repeated manner until being fully filled.

26. The method of claim 20, wherein the lower electrode includes a wire for a connection with a flexible printed circuit board supplying a power source.

27. The method of claim 26, wherein the wire is formed by inkjet printing of an electrode material.

28. The method of claim 18, further comprising performing a poling process in order to make a direction of dipoles of the piezoelectric actuator consistent.
